(19) United States
(12) Patent Application Publication
(10) Pub. No.: US 2025/0124203 A1
(43) Pub. Date: Apr. 17, 2025

(54) Systems and Methods for Simulating Hardened Circuitry via Virtual Interface

(71) Applicant: Altera Corporation, San Jose, CA (US)

(72) Inventors: Onkar Patki, Bangalore (IN); Laxita Mali, Bengaluru (IN); Amit Waghmare, Nagpur (IN)

(21) Appl. No.: 18/991,091

(22) Filed: Dec. 20, 2024

(51) Int. Cl. G06F 30/3308; G06F 115/08; G06F 117/04

(52) U.S. Cl. CPC G06F 30/3308; G06F 2115/08; G06F 2117/04

(57) ABSTRACT

Embodiments herein are directed to systems and methods for elaborating and simulating hard intellectual property (IP) cores via virtual interface. Such a system may include a processing circuitry and a memory. The memory may include computer-readable instructions that the processing circuitry may execute to produce a simulation of soft logic circuitry, a simulation of hard logic circuitry, and a simulation wrapper around the simulation of hard logic circuitry to provide a virtual interface between the simulation of the soft logic circuitry and the simulation of the hard logic circuitry.

### BACKGROUND

The present disclosure relates generally to programmable logic devices. More particular, the present disclosure relates to a virtual interface within a programmable logic device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

In integrated circuit design, there are two types of intellectual property (IP) components, hard IP and soft IP. Hard IP describes pre-built, hardened IP cores implemented on an integrated circuit. Soft IP describes IP cores implemented via programmable fabric (e.g., of a field-programmable gate array (FPGA)). Hard IP may include network-on-chip (NOC) or multi-lane Ethernet. Hard IP may be shared across multiple channels of soft IP (or independent multiple IP), or hard IP may be dedicated to individual soft IP cores.

Simulating hard IP may differ from simulating soft IP due to the pre-built nature of hard IP when hard IP spans across multiple channelized IP. In some instances, developers may be unable to instantiate hard IP (e.g., a NOC) within each channel of sub-IP. In some cases, this may be solved by instantiating at global/system level. However, this may prevent parallel development and/or create dependencies such that testing cannot be performed until each channel of sub-IP is configured correctly to the hard IP.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is an illustration of a simulation intellectual property (IP) wrapper that may be implemented in a programmable logic device, in accordance with an embodiment of the present disclosure;

FIG. 4 is a flowchart of an example method for simulating placement and configuration in a simulation, in accordance with an embodiment of the present disclosure; and

FIG. 5 is an integrated circuit system on which the simulation of FIG. 4 may be carried out, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure describes systems and methods related to a virtual interface within a programmable logic device (PLD), such as a field-programmable gate array (FPGA). In certain embodiments, a hard intellectual property (IP) may be instantiated as a singleton entity. As defined herein, a singleton entity is a software design pattern that may restrict the instantiation of a class to a singular instance. Therefore, only one instance of the hard IP may be created, and the hard IP may exist outside of a hierarchical structure. Instantiating the hard IP as a singleton entity may enable the hard IP to be embedded within a globally present block while remaining flexible enough to be connected to other IPs within an environment, regardless of a position of the other IPs within the hierarchical structure.

Instantiating the hard IP as a singleton entity may provide advantages in terms of modularity and reusability. Instantiating the hard IP as a singleton entity enables instantiation of the hard IP within a software-based simulation wrapper. The simulation wrapper may leverage index-based virtual interfaces to facilitate communication with the input and output interfaces of the hard IP. Each input and output of the simulation wrapper may be based on the location/placement of a hard IP component. For example, the inputs and outputs of a NOC may be represented by a corresponding input/output of the simulation wrapper, and the behavior of each input/output of the NOC (and the behavior of one or more soft IP communicating with the respective inputs/outputs of the NOC) may be simulated by the simulation wrapper without instantiating the shared hard IP in every design or channelized IP, and without instantiating the shared hard IP at a system level with direct connections to fixed ports. In other words, individual inputs and outputs of the NOC (or other hard IP) may be simulated with respect to corresponding soft IP without having to simulate every input and output of the NOC and every piece of soft IP coupled to the respective inputs and outputs of the NOC.

Accordingly, instantiating the hard IP as a singleton entity within the simulation wrapper ensures consistency and reduces the risk of conflicts that may arise from having multiple instantiations. Placing the hard IP outside of the hierarchical structure may simplify management and allow for easier connection to other IPs within an electronic design automation (EDA) tool environment. Therefore, the overall flexibility and scalability of the hard IP may be enhanced. Additionally, instantiating the hard IP as a singleton facilitates better organization and maintenance of a design because the hard IP remains separate from the hierarchical structure while still accessible for any necessary connections. In this manner, instantiating the hard IP as a single entity may streamline a development process and improve overall design efficiency.

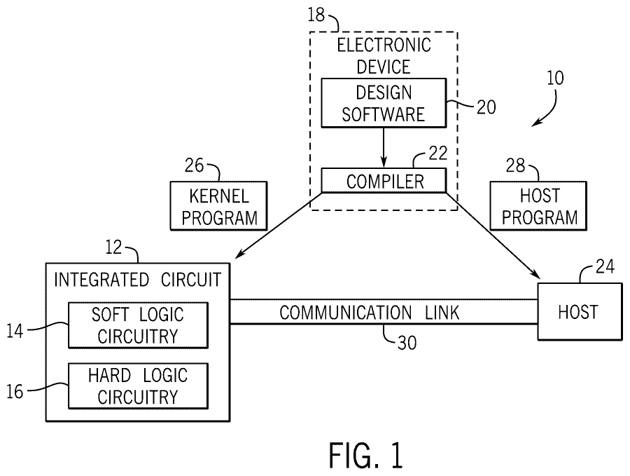

With the foregoing in mind, FIG. 1 illustrates a block diagram of a system 10 that may be used to implement the software-based simulation wrapper of hard IP described in this disclosure on an integrated circuit system 12 (e.g., a single monolithic integrated circuit or a multi-die system of integrated circuits). The integrated circuit system 12 may include a single integrated circuit, multiple integrated circuits in a package, or multiple integrated circuits in multiple packages communicating remotely (e.g., via wires or traces). In some cases, the designer may specify a high-level program to be implemented, such as an OPENCL® program that may enable the designer to more efficiently and easily provide programming instructions to configure a set of programmable logic cells for the integrated circuit system 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit system 12.

The integrated circuit system 12 may include a field-programmable gate array (FPGA). The FPGA includes soft logic circuitry 14 and hard logic circuitry 16. The soft logic circuitry 14 may include a soft logic circuit design (e.g., soft IP cores) implemented using the programmable fabric of the FPGA. The hard logic circuitry 16 may include pre-built hardened IP on the FPGA. For example, the hard IP may include a network-on-chip (NOC), network circuitry (e.g., multi-lane Ethernet), digital signal processing logic, an encrypted circuit, memory, an accelerator (e.g., hardware accelerator), or any combination thereof. The network circuitry may comprise ethernet circuitry.

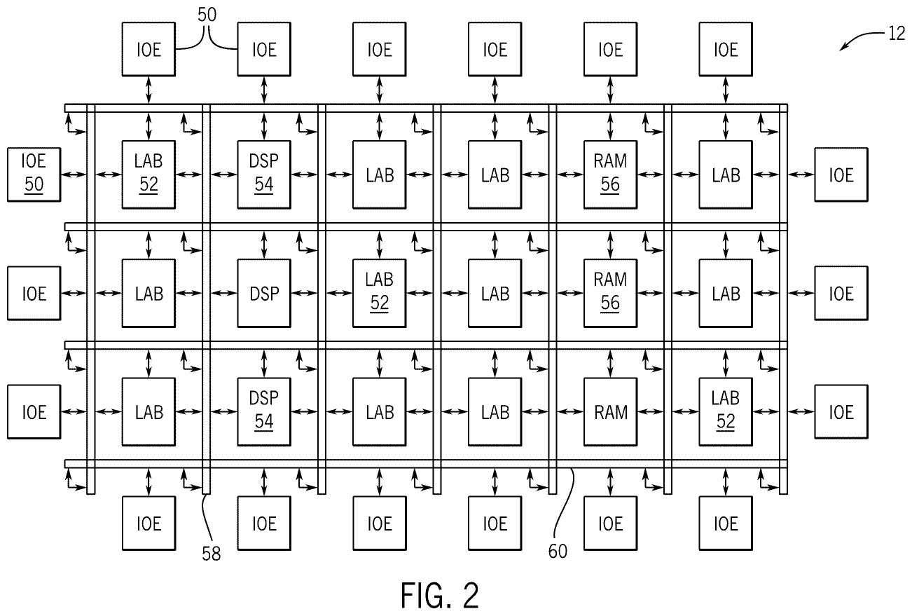

In a configuration mode of the integrated circuit system 12, a designer may use an electronic device 18 (e.g., a computer) to implement high-level designs (e.g., a system user design) using design software 20, such as a version of INTEL® QUARTUS® by INTEL CORPORATION. The electronic device 18 may use the design software 20 and a compiler 22 to convert the high-level program into a lower-level description (e.g., a configuration program, a bitstream). The compiler 22 may provide machine-readable instructions representative of the high-level program to a host 24 and the integrated circuit system 12. The host 24 may receive a host program 28 that may control or be implemented by a kernel program 26. To implement the host program 28, the host 24 may communicate instructions from the host program 28 to the integrated circuit system 12 via a communication link 30 that may include, for example, direct memory access (DMA) communications or peripheral component interconnect express (PCIe) communications. As will be described in greater detail below in FIG. 2, in some embodiments, the kernel program 26 and the host 24 may configure programmable logic array blocks on the integrated circuit system 12. The programmable logic array blocks may include circuitry and/or other logic elements and may be configurable to implement a variety of functions in combination with digital signal processing (DSP) blocks.

The designer may use the design software 20 to generate and/or to specify a low-level program, such as the low-level hardware description languages described above. Further, in some embodiments, the system 10 may be implemented without the separate host program 28. Thus, embodiments described herein are intended to be illustrative and not limiting.

An illustrative embodiment of the integrated circuit system 12 such as a programmable logic device (PLD) that may be configured to implement a circuit design is shown in FIG. 2. As illustrated in FIG. 2, the integrated circuit system 12 (e.g., an FPGA) may include a two-dimensional array of functional blocks, including programmable logic blocks 52 (also referred to as logic array blocks (LABs) or configurable logic blocks (CLBs)) and other functional blocks, such as embedded digital signal processing (DSP) blocks 54 and embedded random-access memory (RAM) blocks 56, for example. Functional blocks such as LABs 52 may include smaller programmable regions (e.g., logic elements, configurable logic blocks, or adaptive logic modules) that receive input signals and perform custom functions on the input signals to produce output signals. LABs 52 may also be grouped into larger programmable regions sometimes referred to as logic sectors that are individually managed and configured by corresponding logic sector managers. The grouping of the programmable logic resources on the integrated circuit system 12 into logic sectors, logic array blocks, logic elements, or adaptive logic modules is merely illustrative. In general, the integrated circuit system 12 may include functional logic blocks of any suitable size and type, which may be organized in accordance with any suitable logic resource hierarchy.

Programmable logic in the integrated circuit system 12 may contain programmable memory elements. Memory elements may be loaded with configuration data (also called programming data or configuration bitstream) using input-output elements (IOEs) 50. Once loaded, the memory elements each provide a corresponding static control signal that controls the operation of an associated functional block (e.g., LABs 52, DSP 54, RAM 56, or IOEs 50).

In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), lookup tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory, configuration random-access memory (CRAM), or programmable memory elements.

In addition, the programmable logic device may have input-output elements (IOEs) 50 for driving signals off the integrated circuit system 12 and for receiving signals from other devices. The IOEs 50 may include parallel input-output circuitry, serial data transceiver circuitry, differential receiver and transmitter circuitry, or other circuitry used to connect one integrated circuit to another integrated circuit. The integrated circuit system 12 may also include programmable interconnect circuitry in the form of vertical routing channels 58 (e.g., interconnects formed along a vertical axis of the integrated circuit system 12) and horizontal routing channels 60 (e.g., interconnects formed along a horizontal axis of the integrated circuit system 12), each routing channel including at least one track to route at least one wire. If desired, the interconnect circuitry may include pipeline elements, and the contents stored in these pipeline elements may be accessed during operation. For example, a programming circuit may provide read and write access to a pipeline element.

The integrated circuit system 12 may be configured to implement a custom circuit design. For example, the configuration RAM may be programmed such that LABs 52, DSP 54, and RAM 56, programmable interconnect circuitry (e.g., vertical routing channels 58 and horizontal routing channels 60), and the input-output elements (IOEs) 50 form the circuit design implementation.

Note that other routing topologies, besides the topology of the interconnect circuitry depicted in FIG. 2, are intended to be included within the scope of the present disclosure. For example, the routing topology may include wires that travel diagonally or that travel horizontally and vertically along different parts of their extent as well as wires that are perpendicular to the device plane in the case of three-dimensional integrated circuits, and the driver of a wire may be located at a different point than one end of a wire. The routing topology may include global wires that span substantially all of the integrated circuit system 12, fractional global wires such as wires that span part of the integrated circuit system 12, staggered wires of a particular length, smaller local wires, or any other suitable interconnection resource arrangement.

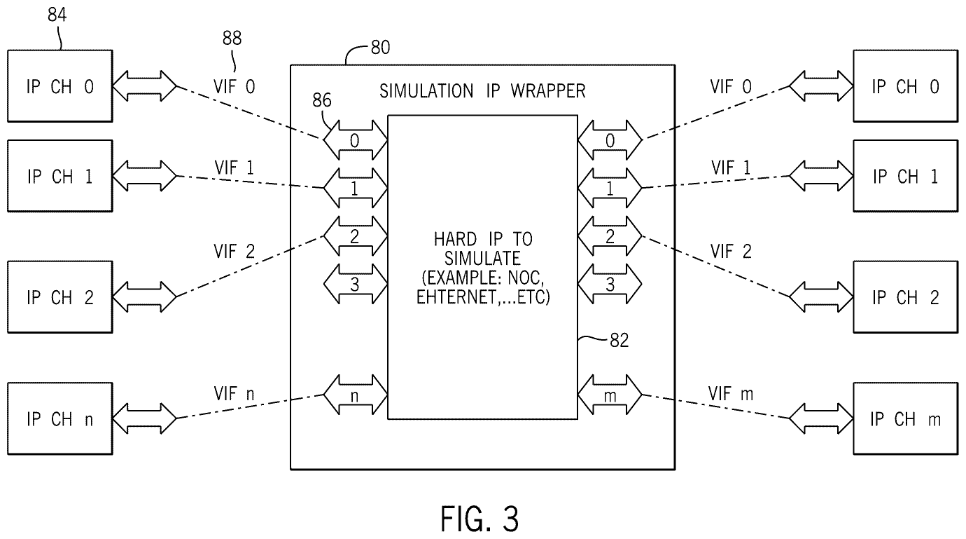

FIG. 3 is an illustration of a simulation intellectual property (IP) wrapper 80 that may be implemented in a programmable logic device, according to embodiments of the present disclosure. Within the simulation IP wrapper 80, hard IP core 82 may be instantiated to enable elaboration and simulation of the hard IP core 82, allowing for efficient configuration management. The hard IP core 82 may include at least a portion of the hard logic circuitry 16 discussed with respect to FIG. 1. As mentioned above, the hard logic circuitry 16 may include network-on-chip (NOC), network circuitry such as multi-lane Ethernet, digital signal processing logic, an encrypted circuit, memory, a hardware accelerator, or any other suitable hard IP cores. Accordingly, the hard IP core 82 may include one or more of the above hard IP cores. The simulation IP wrapper 80 may provide a virtual configuration of the hard IP core 82 (e.g., NOC) based on one or more parameters, such as a per-interface clock and reset signals for AXI4 and AXI4 Lite interfaces, a number of AXI4 interfaces, an AXI4 data mode, an AXI4 interface handshake, maximum outstanding read/write commands, one or more clocks of wide read and write AXI channels that are independent from the NOC initiator hardware clock, a NOC QOS mode, and so on. In the case of the hard IP core 82 including multi-lane Ethernet, the parameters could include individual lane speed and related internal configurations of internal Ethernet components.

To facilitate communication between one or more soft IP cores 84 and input and output ports 86 (e.g., the IOEs 50) of the hard IP core 82, a virtual interface may be implemented in the integrated circuit system 12 (e.g., programmable logic device). The virtual interface may enable the simulation IP wrapper 80 to simulate the inputs and output ports 86 of the hard IP core 82. This may enable simulation of the interactions, data traffic flow, congestion, and so on between the hard IP core 82 and one or more soft IP cores 84 without instantiating the hard IP core 82 in every soft IP core 84. This enables a subset of the soft IP cores 84 (e.g., one soft IP core 84, such as IP CH 0) to be simulated without all other soft IP cores 84 being ready for runtime or simulation. This may be beneficial as, without the simulation IP wrapper 80, one unconfigured or incorrectly configured connection between soft IP core 84 (e.g., IP CH m) and the hard IP core 82 may cause runtime or simulation issues for all other connections, such as the IP CHO, which may be the only IP core 84 for which elaboration and simulation is desired at any moment. Additionally, the virtual interface may accommodate various parameter definitions of the hard IP core 82. The parameters may be configured based on a configuration provided by EDA tools such as Quartus® Prime Design Software by Altera® Corporation. It should be noted that the soft IP components 84 may collectively include at least a portion of the soft logic circuitry 14.

Either internal soft IP or external IP may use an index-based virtual interface method to facilitate communication with the IOEs 50 of the hard logic circuitry 16. The simulation IP wrapper 80 may include input and output ports 86 based on a location/placement of components (e.g., the IOEs 50) of the hard IP core 82. The index based virtual interface method may align interfaces between the hard IP core 82 and soft IP cores 84 through virtual interface indexing to optimize communication pathways. Virtual interface indexing may facilitate efficient data exchange and seamless integration across different IP components (e.g., the hard IP core 82 and one or more soft IP core 84) within the integrated circuit system 12. For example, a device with hardened NOC may contain various entry and exit points (e.g., the inputs and output ports 86). The inputs and output ports 86 may be connected to the soft IP core 84 using the index based virtual interface method.

Moreover, the hard IP core 82 may be instantiated as a singleton (e.g., single) entity within the simulation IP wrapper 80. Therefore, the hard logic circuitry 16 may exist outside of a hierarchy. Because of this process, the hard IP core 82 may remain hidden from a user, only displaying multiple soft IP cores 84 (e.g., channelized IP cores). Connections between the soft IP cores 84 and the hard IP cores 82 may be generated using the virtual interface. For example, the virtual interface 88 indexing may establish a connection (e.g., a channel) between the soft IP cores 84 and the input and output ports 86 of the hard IP core 82.

Communication between soft IP cores 84 and the simulation IP wrapper 80 of the hard IP core 82 may be established via the virtual interfaces 88. Specifically, the virtual interfaces 88 may provide a registration between a channel of the soft logic circuitry 14 (e.g., between a channel of one or more soft IP cores 84) and the hard logic circuitry 16 (e.g., the hard IP core 82). A registration function may be used to establish communication between the soft logic circuitry 14 and the hard logic circuitry 16. The registration function below may be used to connect an indexed portion of the simulation IP wrapper 80 with one or more respective soft IP cores 84.
Soft_IP.register_if(simulation_wrapper.get_if(index));

Additionally, the registration function below may be used to connect the indexed portion of the simulation IP wrapper 80 with one or more memory IP cores. The memory IP cores may be used to configure programmable logic devices or application-specific integrated circuits.
Simulation_wrapper.register_if(HBM_IP.get_if( ), index);

While the two functions above may be used to establish communication, it should be noted that communication may be established in another way. The simulation IP wrapper 80 is utilized in a method discussed in detail below.

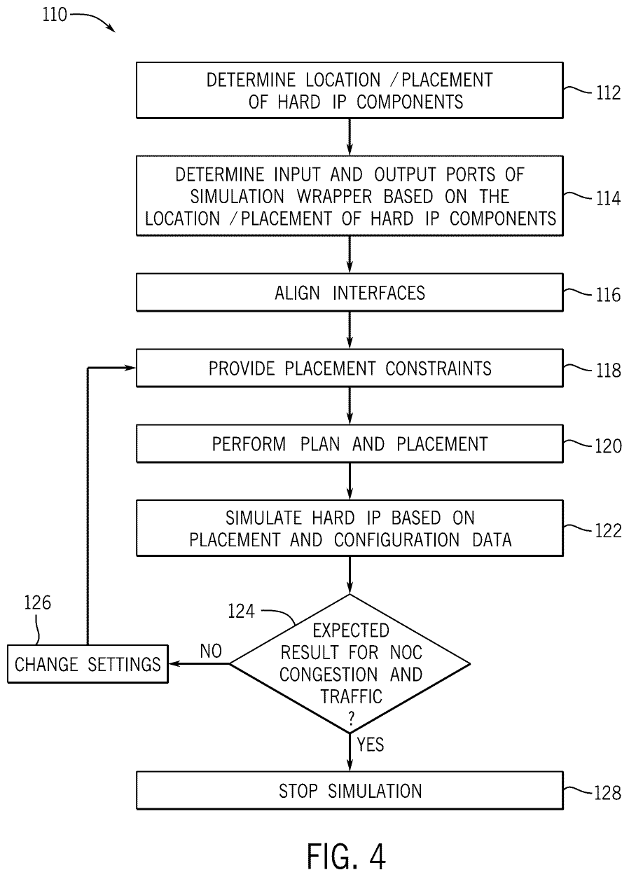

FIG. 4 is a flowchart of an example method 110 for simulating placement and configuration, according to embodiments of the present disclosure. The method 110 may be performed by the compiler 22, the integrated circuit system 12 (e.g., a programmable logic device such as an FPGA or an ASIC that includes programmable logic circuitry), or components and/or algorithms thereof. The method 110 includes various steps represented by blocks. Although the flowchart illustrates the steps in a certain sequence, it should be understood that the steps may be performed in any suitable order and certain steps may be carried out simultaneously, where appropriate. Further, certain steps or portions of the method 110 may be performed by separate systems or devices. It should be noted that the method 110 may be performed during manufacture, or may be performed during normal (e.g., runtime) operation of the integrated circuit system 12.

In some instances, hard IP simulation methods may differ from simulating user-defined logic due to the pre-built nature of hard IP. To simulate hard IP (e.g., the hard IP core 82), some vendors may provide software-based simulation models to replicate the behavior of the hard IP. However, in some cases vendor-provided models may not accurately represent the behavior of the congestion, latency, throughput, etc. of the hard IP. In hardware design, placement and configuration may be valuable for performance. If the user desires to simulate a design with either specific configuration or the specific location of the hard IP, the method 110 may be used. It should be noted that the method 110 is applicable for FPGA design, ASIC design, or any other PLD design.

The method 110 may be performed if a user wants to simulate a design with either a specific configuration or a specific location of the hard IP core 82. With this approach, the user may perform dedicated simulations on a required part of the hard IP core 82 (e.g., a partially connected system). In process block 112, compiler 22 may determine the location/placement of each component of the hard IP core 82 associated with the integrated circuit system 12 (e.g., an FPGA or an ASIC). In hardware design, the placement and the configuration are important for performance.

In process block 114, the compiler 22 may determine the input and output ports 86 of the simulation IP wrapper 80 based on the location/placement of corresponding input/output ports of the hard IP core 82. For example, the compiler 22 may determine the input and output ports 86 of the simulation IP wrapper 80 based on the location of inputs and outputs of a NOC, such that the input and output ports 86 each corresponding to an input and output of the NOC.

In process block 116, the compiler 22 may align the interfaces of the simulation IP wrapper 80 to the interfaces of the hard IP core 82 using virtual interface indexing. Virtual interface indexing may be used to enhance communication pathways and facilitate efficient data exchange and seamless integration across different IP components within the integrated circuit system 12.

In process block 118, the compiler 22 may provide placement constraints. The placement constraints may include determining which inputs and outputs of a soft IP core 84 may correspond to which respective inputs and output ports 86 of the simulation IP wrapper 80. For example, if a user desires to have the soft IP core 84 IP CHO correspond to the input and output 86 0 of the simulation IP wrapper 80, such a placement constraint may be provided for via Quartus Quartus® Prime Design Software by Altera® Corporation, or other EDA tools. For example, the design may place an initiator for memory. Based on the placement constraints, the user may manipulate the placement of the initiator until a desired design is achieved. Then, the compiler 22 may configure placement and configuration data.

In process block 120, the compiler 22 may perform planning and placement of the soft IP cores 84 such that the soft IP cores 84 are mapped to corresponding input and output ports of the simulation IP wrapper 80. As the input and output ports 86 of the simulation IP wrapper 80 correspond to input and output ports of the hard IP core 82 after the processes of process blocks 114 and 116, and one or more soft IP cores 84 are mapped to one or more inputs and output ports 86 of the simulation IP wrapper 80 in the process block 118, placement may communicatively couple the soft IP cores 84 to the inputs and outputs of the simulation IP wrapper 80 to enable simulation of the interactions between the soft IP cores 84 and the hard IP core 82. Continuing with the example above, if a user desires to simulate the interaction between the soft IP core 84 IP CH 0 and the hard IP core 82 at input and output port 86, the compiler 22 may place routing between the virtual interface VIF 0 between IP CH 0 and input/output 0. It should be noted that the planning and placement may be performed for any soft IP core 84 for which communication with the hard IP core 82 via the placement constraints. The process of process block 120 may align soft IP cores 84 to the input and output ports 86 of the hard IP core 82 in batches or one-by-one, depending on which soft IP cores 84 the user desires to simulate, how many soft IP cores 84 the user desires to simulate, and so on.

During the plan and placement stage, the placement and configuration data are compiled into a configuration file, which may include details about parameter definition configurations and placements. It is important to ensure a hardware simulation is associated with physical connections.

In process block 122, the compiler 22 may simulate the hard IP core 82 based on the placement and configuration data from the configuration file. Using the configuration file, a simulation is performed which may replicate hardware behavior via the simulation IP wrapper 80 and provide the user with performance and congestion details associated with the hard IP core 82. The virtual interfaces 88 simulate physical wire connections such as a wire connecting the soft IP cores 84 to the input and output ports 86 of the hard IP core 82 determined by the placement and configuration data. The simulation shows the user an expected physical performance of the physical hardware.

In query block 124, the compiler 22 may determine if the simulation returns an expected result for interaction between the soft IP cores 84 and the hard IP core 82. For example, if the hard IP core 82 includes a NOC, the compiler 22 may determine whether there is an expected or desired level congestion and traffic at the input and output ports 86. The simulation establishes a baseline performance when run for a first time. A simulation result may show how the traffic is expected to flow in the physical hardware. For example, if a certain switch is facing more traffic than desired, the user may change the placement. This step may allow the user to alter the configuration until a desired amount of traffic is achieved.

If the simulation result is not expected, the user may change a location of a connection associated with a given soft IP core 84 to achieve better performance, or the user may change some settings (e.g., via an EDA tool) to update the placement constraints in the process block 118. Returning to our previous example wherein the user desires to simulate the interaction between the soft IP core 84 IP CH 0 and the hard IP core 82 at the input/output port 0, if the simulation result is not expected or desired, the compiler 22 may, in process block 126, change the settings (e.g., provide new placement constraints). After providing the new placement constraints, the compiler 22 may remap the soft IP cores 84 to different input and output ports 86 of the simulation IP wrapper 80. For example, the soft IP core 84 IP CH 0 may be remapped such that it is communicatively coupled to another input/output port n instead of input/output port 0. The entire process may be repeated for performance tuning by simulating real register-transfer level (RTL). After altering the configuration, a new simulation may be run and new data may be generated from an updated placement. This process may be repeated until a desired performance is achieved.

If the simulation result is expected, then compiler 22 may continue to process block 128. In process block 128, the index based virtual interface method may terminate and another simulation may begin from the process block 112.

The method 110 described above is applicable for FPGA designs, but it may be extended for ASIC designs, or any other suitable design. For FPGAs, once the design is created, the user may need to perform the plan and placement stage of the FPGA with EDA tools such as Quartus® Prime Design Software by Altera® Corporation.

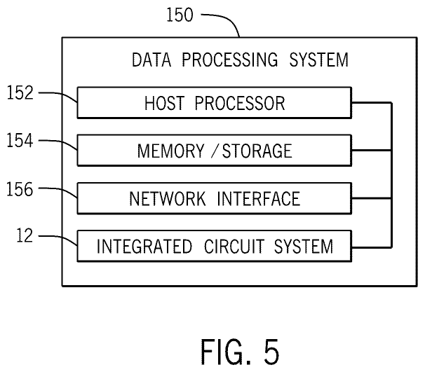

The processes discussed above may be carried out on the integrated circuit system 12, which may be a component included in a data processing system, such as a data processing system 150, shown in FIG. 5. The data processing system 150 may include the integrated circuit system 12 (e.g., a programmable logic device), a host processor 152, memory and/or storage circuitry 154, and a network interface 156. The data processing system 150 may include more or fewer components (e.g., electronic display, user interface structures, application specific integrated circuits (ASICs)). The host processor 152 may include any of the foregoing processors that may manage a data processing request for the data processing system 150 (e.g., to perform elaboration and simulation, to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 154 may include random access memory (RAM), read-only memory (ROM), one or more hard drives, flash memory, or the like. The memory and/or storage circuitry 154 may hold data to be processed by the data processing system 150. In some cases, the memory and/or storage circuitry 154 may also store configuration programs (e.g., bitstreams, mapping function) for programming the integrated circuit system 12. The network interface 156 may allow the data processing system 150 to communicate with other electronic devices. The data processing system 150 may include several different packages or may be contained within a single package on a single package substrate. For example, components of the data processing system 150 may be located on several different packages at one location (e.g., a data center) or multiple locations. For instance, components of the data processing system 150 may be located in separate geographic locations or areas, such as cities, states, or countries.

The data processing system 150 may be part of a data center that processes a variety of different requests. For instance, the data processing system 150 may receive a data processing request via the network interface 156 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the programmable routing bridge described herein may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. A system comprising:
processing circuitry; and
memory comprising one or more tangible, non-transitory, computer-readable media, comprising computer-readable instructions that, when executed by the processing circuitry produce:
a simulation of soft logic circuitry;
a simulation of hard logic circuitry; and
a simulation wrapper around the simulation of hard logic circuitry to provide a virtual interface between the simulation of the soft logic circuitry and the simulation of the hard logic circuitry.

EXAMPLE EMBODIMENT 2. The system of example embodiment 1, wherein the soft logic circuitry comprises a soft logic circuit design of a field-programmable gate array.

EXAMPLE EMBODIMENT 3. The system of example embodiment 1, wherein the hard logic circuitry comprises a network-on-chip (NOC).

EXAMPLE EMBODIMENT 4. The system of example embodiment 1, wherein the hard logic circuitry comprises network circuitry.

EXAMPLE EMBODIMENT 5. The system of example embodiment 4, wherein the network circuitry comprises Ethernet circuitry.

EXAMPLE EMBODIMENT 6. The system of example embodiment 1, wherein the hard logic circuitry comprises digital signal processing logic.

EXAMPLE EMBODIMENT 7. The system of example embodiment 1, wherein the hard logic circuitry comprises an encrypted circuit.

EXAMPLE EMBODIMENT 8. The system of example embodiment 1, wherein the hard logic circuitry comprises memory.

EXAMPLE EMBODIMENT 9. The system of example embodiment 1, wherein the simulation wrapper provides a virtual configuration of the hard logic circuitry based on one or more parameters.

EXAMPLE EMBODIMENT 10. The system of example embodiment 9, wherein the one or more parameters of an integrated circuit device comprises a per-interface clock and reset signal, a number of interfaces, a data mode, an initiator hardware clock, or any combination thereof.

EXAMPLE EMBODIMENT 11. The system of example embodiment 1, wherein the memory comprising the one or more tangible, non-transitory, computer-readable media, comprising computer-readable instructions that, when executed, cause a plurality of input/output (I/O) ports of the simulation wrapper to map to corresponding I/O ports of the hard logic circuitry.

EXAMPLE EMBODIMENT 12. A method for generating a system design of an integrated circuit device, comprising:
determining a location of a first plurality of input/output (I/O) ports associated with hard logic circuitry;
determining a second plurality of I/O ports associated with a simulation wrapper based on respective locations of the first plurality of I/O ports associated with the hard logic circuitry;
mapping a third plurality of I/O ports associated with soft logic circuitry to the second plurality of I/O ports; and
simulating an interaction between the soft logic circuitry and the hard logic circuitry via the simulation wrapper.

EXAMPLE EMBODIMENT 13. The method of example embodiment 12, wherein the hard logic circuitry comprises a network-on-chip (NOC).

EXAMPLE EMBODIMENT 14. The method of example embodiment 12, comprising remapping at least one I/O port of the third plurality of I/O ports to a different I/O port of the second plurality of I/O ports based on a simulation result.

EXAMPLE EMBODIMENT 15. The method of example embodiment 12, wherein the method is performed during normal operation of the integrated circuit device.

EXAMPLE EMBODIMENT 16. The method of example embodiment 12, wherein the method is performed during manufacturing of the integrated circuit device.

EXAMPLE EMBODIMENT 17. A tangible, non-transitory, computer-readable medium, comprising computer-readable instructions that, when executed by processing circuitry of an integrated circuit device, produce:
a simulation of soft logic circuitry;
a simulation of hard logic circuitry; and
a simulation wrapper around the simulation of hard logic circuitry to provide a virtual interface between the simulation of the soft logic circuitry and the simulation of the hard logic circuitry.

EXAMPLE EMBODIMENT 18. The tangible, non-transitory, computer-readable medium of example embodiment 17, wherein the hard logic circuitry is instantiated as a singleton entity within the simulation wrapper.

EXAMPLE EMBODIMENT 19. The tangible, non-transitory, computer-readable medium of example embodiment 17, wherein a first plurality of input/output (I/O) ports of the simulation wrapper are mapped to a second plurality of I/O ports of the hard logic circuitry.

EXAMPLE EMBODIMENT 20. The tangible, non-transitory, computer-readable media of example embodiment 17, wherein the hard logic circuitry comprises multi-lane Ethernet circuitry.

What is claimed is:

1. A system comprising:
processing circuitry; and
memory comprising one or more tangible, non-transitory, computer-readable media, comprising computer-readable instructions that, when executed by the processing circuitry produce:
a simulation of soft logic circuitry;
a simulation of hard logic circuitry; and
a simulation wrapper around the simulation of hard logic circuitry to provide a virtual interface between the simulation of the soft logic circuitry and the simulation of the hard logic circuitry.

2. The system of claim 1, wherein the soft logic circuitry comprises a soft logic circuit design of a field-programmable gate array.

3. The system of claim 1, wherein the hard logic circuitry comprises a network-on-chip (NOC).

4. The system of claim 1, wherein the hard logic circuitry comprises network circuitry.

5. The system of claim 4, wherein the network circuitry comprises Ethernet circuitry.

6. The system of claim 1, wherein the hard logic circuitry comprises digital signal processing logic.

7. The system of claim 1, wherein the hard logic circuitry comprises an encrypted circuit.

8. The system of claim 1, wherein the hard logic circuitry comprises memory.

9. The system of claim 1, wherein the simulation wrapper provides a virtual configuration of the hard logic circuitry based on one or more parameters.

10. The system of claim 9, wherein the one or more parameters of an integrated circuit device comprises a per-interface clock and reset signal, a number of interfaces, a data mode, an initiator hardware clock, or any combination thereof.

11. The system of claim 1, wherein the memory comprising the one or more tangible, non-transitory, computer-readable media, comprising computer-readable instructions that, when executed, cause a plurality of input/output (I/O) ports of the simulation wrapper to map to corresponding I/O ports of the hard logic circuitry.

12. A method for generating a system design of an integrated circuit device, comprising:
determining a location of a first plurality of input/output (I/O) ports associated with hard logic circuitry;
determining a second plurality of I/O ports associated with a simulation wrapper based on respective locations of the first plurality of I/O ports associated with the hard logic circuitry;
mapping a third plurality of I/O ports associated with soft logic circuitry to the second plurality of I/O ports; and
simulating an interaction between the soft logic circuitry and the hard logic circuitry via the simulation wrapper.

13. The method of claim 12, wherein the hard logic circuitry comprises a network-on-chip (NOC).

14. The method of claim 12, comprising remapping at least one I/O port of the third plurality of I/O ports to a different I/O port of the second plurality of I/O ports based on a simulation result.

15. The method of claim 12, wherein the method is performed during normal operation of the integrated circuit device.

16. The method of claim 12, wherein the method is performed during manufacturing of the integrated circuit device.

17. A tangible, non-transitory, computer-readable medium, comprising computer-readable instructions that, when executed by processing circuitry of an integrated circuit device, produce:
a simulation of soft logic circuitry;
a simulation of hard logic circuitry; and
a simulation wrapper around the simulation of hard logic circuitry to provide a virtual interface between the simulation of the soft logic circuitry and the simulation of the hard logic circuitry.

18. The tangible, non-transitory, computer-readable medium of claim 17, wherein the hard logic circuitry is instantiated as a singleton entity within the simulation wrapper.

19. The tangible, non-transitory, computer-readable medium of claim 17, wherein a first plurality of input/output (I/O) ports of the simulation wrapper are mapped to a second plurality of I/O ports of the hard logic circuitry.

20. The tangible, non-transitory, computer-readable media of claim 17, wherein the hard logic circuitry comprises multi-lane Ethernet circuitry.
